(19) United States
(12) Patent Application Publication
(10) Pub. No.: US 2011/0015551 A1
(43) Pub. Date: Jan. 20, 2011

(54) AUXILIARY EXERCISE EQUIPMENT

(75) Inventors: Takao Gotou, Hirakata-shi (JP); Takahisa Ozawa, Katano-shi (JP); Naoto Shirasawa, Kyoto-shi (JP)

Correspondence Address: EDWARDS ANGELL PALMER & DODGE LLP, P.O. BOX 55874, BOSTON, MA, 02205, US

(73) Assignee: PANASONIC ELECTRIC WORKS CO., LTD., KADOMA-SHI (JP)

(21) Appl. No.: 12/736,304

(22) PCT Filed: Mar. 31, 2008
(86) PCT No.: PCT/JP2008/056437

§ 371 Date: Sep. 28, 2010

(51) Int. Cl. A61H 1/00

(52) U.S. Cl. 601/5

(57) ABSTRACT

An auxiliary exercise equipment can prevent a user from having a fall due to loss of a balance, and can be operated to start and stop a passive exercise and to change types of the passive exercise immediately. The auxiliary exercise equipment comprises left and right steps, a passive exercise generating means, and a handle bar. A user's left and right feet are rested on the left and right steps, respectively. The passive exercise generating means comprises a step rotary driving unit which is configured to change a vertical position relation between front and rear ends of each of the left and right steps while being slid and reciprocated. The handle bar prevents the user from having a fall. The handle bar is provided with a switch for starting, stopping, or changing a passive exercise.

### TECHNICAL FIELD

The present invention relates generally to auxiliary exercise equipments which make a user perform user's leg exercise, and more particularly to an auxiliary exercise equipment that provides the user's leg with a passive exercise.

### BACKGROUND ART

In the past, there have been proposed various types of auxiliary exercise equipments which assist a user to stretch user's muscles without effort but with an aid of external forces being applied to the user in order to give an exercise effect. These equipments applying to the user's leg are known to be configured so that the user can simulate a walking motion in the standing position for the purpose of prevention of knee osteoarthritis and walking exercises (for example, see patent document 1).

The walk experience equipment described in the patent document 1 is configured so that a walk-base horizontal driving unit drives to rotate left and right walk-bases in a forward/rearward direction in order to change a vertical position of the user's foot and an inclination angle of the user's sole. Furthermore, the left and right walk-bases can be rotated in a left-and-right direction in order to change the foot's direction and thereby a passive exercise can be performed.

The patent document 1: Japanese Patent Application Laid-Open No. 10-55131

### DISCLOSURE OF THE INVENTION

### Problems to be Solved by the Invention

However, the above equipment in the patent document 1 do not comprise a handle bar for preventing the user from having a fall due to loss of a balance, and has a problem that it is impossible to easily and immediately operate to start and stop the passive exercise and to change types and a dynamic level etc. of the passive exercise.

It is an object of the present invention to provide an auxiliary exercise equipment which can prevent a user from having a fall due to loss of a balance, and can be operated to start and stop a passive exercise and to change types and a dynamic level etc. of the passive exercise immediately.

### Means for Solving the Problem

An auxiliary exercise equipment of the present invention comprises left and right steps, a passive exercise generating means, and a handle bar. A user's left and right feet are rested on the left and right steps, respectively. The passive exercise generating means comprises a step rotary driving unit. The step rotary driving unit is configured to change a vertical position relation between front and rear ends of each of the left and right steps while being slid and reciprocated. The handle bar prevents the user from having a fall. The handle bar is provided with a switch for starting, stopping, or changing a passive exercise.

The auxiliary exercise equipment may comprise a platform. The left and right steps are located on a top surface of the platform. The handle bar comprises left and right handle bars which are located so as to extend from the left and right steps or left and right sides of the platform, respectively. The user can grip the left and right handle bars with one's left and right hands, respectively. The left and right handle bars comprise the switch.

The handle bar may be located to be movable with respect to the platform so that the passive exercise is performed.

The switch is operated by the user and thereby the passive exercise may be started.

The switch is operated by the user and thereby a stroke of sliding and reciprocating or rotation may be of the step changed in the passive exercise.

The switch is operated by the user and thereby different types of the passive exercise may be performed.

An elastic member or a viscous member may be located in a connection part connecting the handle bar and the platform or the step, or in an intermediate position of the handle bar.

### ADVANTAGEOUS EFFECT OF THE INVENTION

The auxiliary exercise equipment of the present invention comprises the handle bar. Thus, the auxiliary exercise equipment can prevent the user from having a fall due to loss of a balance when the user grips the handle bar, and can be operated to start and stop a passive exercise and to change types and a dynamic level etc. of the passive exercise via the handle bar easily, immediately and certainly.

The left and right steps are located on a top surface of the platform and the handle bar comprises left and right handle bars which are located so as to extend from the platform or the left and right steps, respectively, and the user can grip the left and right handle bars with one's left and right hands, respectively, and the left and right handle bars comprise the switch, and thereby the user can get more sense of stability and a freedom of the switch operation can be increased.

The switch is operated by the user and thereby the passive exercise is started. Thus, the auxiliary exercise equipment can prevent from starting the passive exercise accidentally.

The switch is operated by the user and thereby a stroke of sliding and reciprocating or rotation of the step is changed in the passive exercise. Thus, the user can control a dynamic level of the passive exercise via the switch operation while griping the handle bar.

The handle bar is located to be movable with respect to the platform, and thus the user can perform not only a passive exercise by the step but a passive exercise by the handle bar or a passive exercise by combination of the step and the handle bar.

The switch is operated by the user and thereby different types of the passive exercise are performed. Thus, the user can change the types of the passive exercise while griping the handle bar.

An elastic member or a viscous member are located in a connection part connecting the handle bar and the platform or the step, or in an intermediate position of the handle bar, and thereby a reaction force or a resisting force is generated when the user moves the handle bar. Thus, a load is generated and the user can train one's muscles.

### BRIEF DESCRIPTION OF THE DRAWINGS

Preferred embodiments of the invention will now be described in further details. Other features and advantages of the present invention will become better understood with regard to the following detailed description and accompanying drawings where:

FIG. 1 is an oblique perspective figure showing an appearance according to an embodiment of the present invention;

FIG. 2 is a perspective plane figure showing a step and a step driving means according to said embodiment;

FIG. 3 is an explanation figure showing an operation of the step driving means according to said embodiment;

FIG. 4 is an oblique perspective figure showing an appearance according to another embodiment of the present invention;

FIG. 5 shows yet another embodiment of the present invention, FIG. 5(a) being an oblique perspective figure showing an appearance, FIG. 5(b) being a side view of an essential part;

FIG. 6 is an explanation figure showing an example of a handle bar driving means;

FIG. 7 is an explanation figure showing another example of the handle bar driving means;

FIG. 8 is an explanation figure showing yet another example of the handle bar driving means;

FIG. 9 is an explanation figure showing yet another example of the handle bar driving means;

FIGS. 10(a) and 10(b) are time chart figures for explaining motions of a handle bar and a step

### EXPLANATION OF REFERENCES

1 STEP
2 STEP DRIVING MEANS
3 PLATFORM
4 HANDLE BAR
41 GRIP
5 SWITCH
62 VISCOUS MEMBER

### BEST MODE FOR CARRYING OUT THE INVENTION

Hereinafter, An embodiment of the present invention is explained based on attached drawings. An auxiliary exercise equipment shown in the figure comprises a platform 3 which is provided on a top surface with left and right steps 1, 1, a step driving means 2 which is located inside the platform 3 and drives the steps 1, 1 as a passive exercise generating means, and a handle bar 4 for preventing a user from having a fall. The user rests one's left and right feet on the steps 1, 1, respectively while standing. In this standing position, the step driving means 2 drives to move the steps 1, 1, and thereby the auxiliary exercise equipment provides the user's leg with a passive exercise.

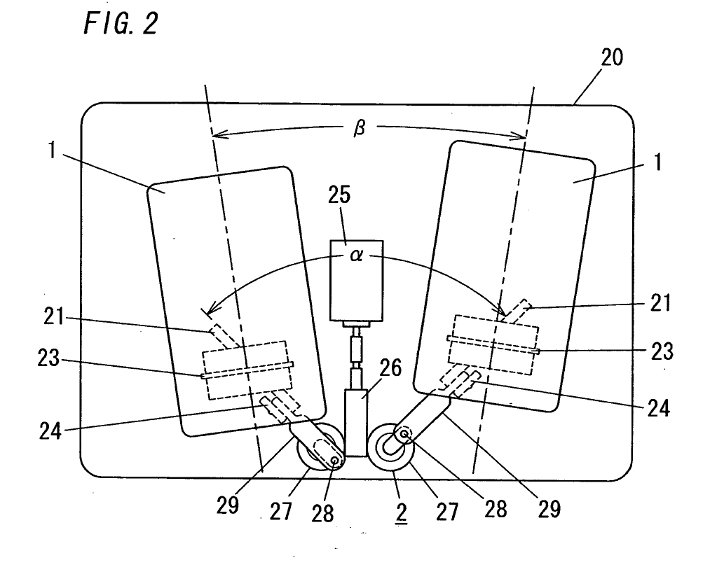

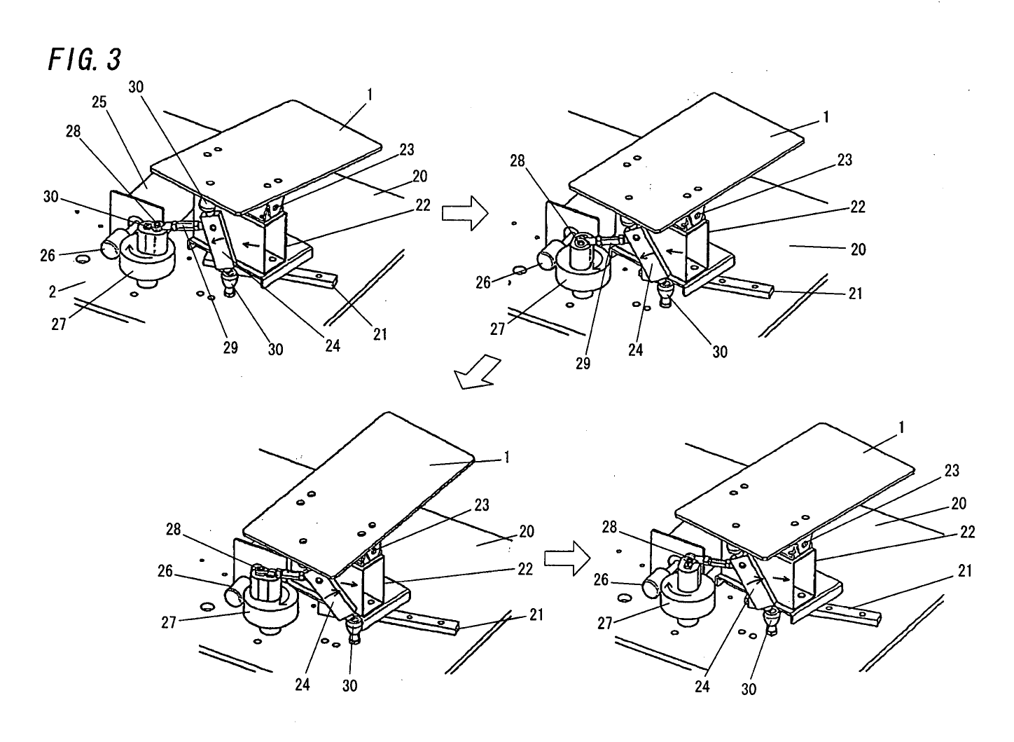

The steps 1, 1 are designed so that a whole of the user's sole can be rested on. A top surface of each of the steps 1, 1 is formed with a material including a large friction coefficient, or into a shape like having a large friction coefficient. A vertical position relation between front and rear ends of the steps 1 is changed while the steps 1 is slid and reciprocated in front-back and left-and-right directions by the step driving means 2, and thereby the user's feet rested on the steps 1, 1 repeat a plantar flexion motion such as moving the user's toe side downward and a dorsi flexion motion such as moving said toe side upward, respectively. The step driving means 2 makes the steps 1, 1 perform such motions, and is shown in FIGS. 2 and 3.

The step driving means 2 shown in these figures includes a step rotary driving unit which is configured to change a vertical position relation between front and rear ends of each of the steps 1, 1. Guide rails 21, 21 are fixed to left and right sides of a top surface of a base plate 20 (or a bottom plate of the platform 3), respectively. A slide block 22 is mounted in each of the guide rails 21, 21. The slide block 22 is provided in one's bottom with a slider unit which is mounted slidably along the guide rail 21. The slide block 22 is provided on one's top surface side with a rotation axis 23. The plate-shaped step 1 is supported rotatably via the rotation axis 23. A link 24 connects one end (a rear end) of each of the steps 1, 1 and the base plate 20. Universal joints 30, 30 are located in a connection unit connecting a lower end of the link 24 and the base plate 20 and a connection unit connecting an upper end of the link 24 and the step 1, respectively.

A motor 25 for driving is located between the left and right slide blocks 22, 22 on the base plate 20. An output shaft 60a of the motor 25 is provided with a worm 26. Worm wheels 27, 27 are located in left and right sides of the worm 26, respectively. Each of the worm wheels 27, 27 gears the worm 26 and comprises an eccentric shaft 28. A connecting rod 29 connects the eccentric shaft 28 and the link 24. In addition, the worm wheel 27 comprising the eccentric shaft 28 and the link 24 are located separately each other in a longitudinal direction of the guide rail 21. Also, universal joints 30, 30 are located in a connection unit connecting one end of the connecting rod 29 and the eccentric shaft 28 and a connection unit connecting the other end of the connecting rod 29 and the link 24, respectively.

The step driving means 2 is controlled by a control circuit (no shown) for controlling a passive exercise generating device.

Now, when the eccentric shaft 28 is rotated by the motor 25 via the worm 26 and the worm wheel 27, the connecting rod 29 constitutes a crank mechanism with the eccentric shaft 28 and makes the link 24 fluctuate around the universal joint 30 of the base plate 20 side. In this fluctuation, the slide block 22 and the step 1 are slid and reciprocated along the guide rail 21 due to a motion of a component corresponding to a longitudinal direction of the guide rail 21.

Here, the left and right guide rails 21, 21 shown in the figure are not located parallel to each other, and are located on the base plate 20 so that a distance between front ends (that is, a end of the user's toe side when the user's foot is rested on the step 1) of the guide rails 21, 21 is larger than a distance between rear ends of the guide rails 21, 21. That is, the guide rails 21, 21 are located to be V-shaped, and thus the slide blocks 22, 22 and the steps 1, 1 mounted the guide rails 21, 21 move so as to spread laterally when moving forward.

By the way, an opening angle “a” is an angle between the V-shaped guide rails 21, 21 shown in the figure and is set as about 90°. For this reason, even if the step 1 is moved when the user's foot is rested on the step 1, a strong shear force can be prevented from acting on the user's knee. And it's preferred that the base plate 20 is configured to move with respect to the platform 3 and thereby the above opening angle “α” is variable.

Also, the connection unit connecting the link 24 and the step 1 can move in a vertical direction by the fluctuation of the link 24, and thus the step 1 rotates around the rotation axis 23. The connecting rod 29 connects the eccentric shaft 28 and the link 24 so that the steps 1 become to be horizontal in middle of a stroke of the above-mentioned sliding motion, and a rear end of the step 1 connected with the link 24 is moved upward in one end of the stroke, and the rear end of the step 1 is moved downward in the other end of the stroke.

For this reason, the step 1 slides along the guide rail 21, and the user's toe side is moved downward when the step 1 moves forward, and the user's heel side is moved downward when the step 1 moves backward. That is, in the present embodiment, the link 24 of the step driving means 2 doubles as the step rotary driving unit.

As shown in FIG. 2, the rotation axis 23 is a rotation center of the step 1, and is located so as to be perpendicular to a longitudinal direction of the step 1 and in a rear end side from a center of the longitudinal direction of the step 1. Furthermore, the rotation axis 23 is set so that one's axis direction is not perpendicular to a longitudinal direction of the guide rail 21, and so that a front end (the user's toe side) of the step 1 is located in a direction deflected inward with respect to the guide rail 21.

Here, the steps 1, 1 are located so that a distance between their front ends is larger than that between their rear ends, and a opening angle “β” of these steps 1, 1 is set within 10 to 30°. Thus, the user can rest one's feet on the steps 1, 1 in the standing position, respectively, while relaxing muscles of one's legs (that is, relaxed state).

The left and right steps 1, 1 is driven by the step driving means 2 and this driving is set so as to change a position of the eccentric shaft 28 mounted in each of the worm wheels 27, 27 gearing the worm 26, and to move the step 1 of the left foot side backward when moving the step 1 of the right foot side forward, and to move the step 1 of the right foot side backward when moving the step 1 of the left foot side forward. That is, this driving is set so that steps 1, 1 are moved each other in an opposite phase. Because the two worm wheels 27, 27 gearing the worm 26 divide a power between left and right sides, motions of the steps 1, 1 are synchronized at any time.

In addition, a foot fixing means, like a strap, may be mounted on the step 1 in order to fix the user's foot, and thereby can prevent the user's foot position from changing.

When the user performs the exercise by using the auxiliary exercise equipment configured as above, the user rests one's left and right feet on the left and right steps 1, 1, respectively, in the standing position while griping the handle bar 4. The user throws an operation switch 5 arranged in an operation panel 4 to activate the above step driving means 2, and thereby the left and right steps 1, 1 are moved each other in the opposite phase as above with respect to front-back and left-and-right directions. Furthermore, each of the steps 1, 1 rotates so that one's front end moves downward when moving forward, and one's rear end moves downward when moving backward.

For this reason, when the user rests one's feet on the steps 1, 1, respectively, the feet is moved in the front-back and left-and-right directions by the motion of the step 1 and motions of a plantar flexion and a dorsi flexion are added to the user's ankle by the rotation of the step 1. In this case, the steps 1, 1 are moved in front-back and left-and-right directions while having a phase difference 180°. Therefore, a weighted center of the user standing on the steps 1, 1 is not moved much in the front-back direction, and the user does not break down a balance much by the motion of the step 1 even if a balance function of the user declines.

A position change of the user's feet changes into a position change similar to the walking motion, while the steps 1, 1 are moved front-back and left-and-right directions in a opposite phase. Thus, the user can stretch at least muscles of one's leg region like walking. Also, the foot position displaces backward from the user's weighted center in the rear end position with respect to a front-back motion, and thereby the user can tense up one's muscles ranging from a back side of a crural area to buttocks in the end position.

In the usual walking, the foot position is mainly moved in a front-back direction. However, when a motion of a left-and-right direction is combined with that of the front-back direction, the user's body trunk twists and thereby the user's internal organs can be stimulated, compared with a motion of only the front-back direction or only the left-and-right direction. Furthermore, more muscles (adducent muscle, rectus femoris, vastus medialis, vastus lateralis, biceps femoris, semitendinosus muscle, and semimembranous muscle etc.) of the leg region and the crural area can be stimulated, and thus the muscles can take in more sugar in spite of a passive exercise and a light load. Therefore, it is expected that type 2 diabetes is ameliorated.

And the Achilles tendon is extended when being dorsiflexed as above, and thus the movable range of the ankle can be spread. A force is applied to the toe when being plantarflexed, and thus a hallux valgus can be alleviated. In addition, the plantar flexion and the dorsi flexion are repeated, and thus the user can stretch the muscles of the leg region which principally involves gastrocnemius muscle and soleus muscle. A venous perfusion is increased in user's legs by the stretch of these muscles and thus leg swelling can be eliminated.

The step driving means 2 starts the operation by throwing the operation switch 5, and stops the operation by throwing the operation switch 5 again. In addition, the step driving means 2 may stop the operation automatically if a predetermined time passes. Furthermore, an operation time of the step driving means 2 may be controlled by the user.

As is clear from the configuration of the above-mentioned step driving means 2, the phase difference between the left and right steps 1, 1 is determined by a position of the eccentric shaft 28 mounted in the worm wheel 27, with respect to sliding in front-back and left-and-right directions. That is, the phase difference is determined by a position in which the worm wheel 27 gears the worm 26. Thus, if this geared position is displaced, arbitrary phase difference can be determined and the steps 1, 1 can also be moved easily in the same phase. When the steps 1, 1 are moved in the same phase, the user's weighted center is moved in a front-back direction. Therefore, the user can exercise not only the leg's muscles but lower back's muscles for keeping balance.

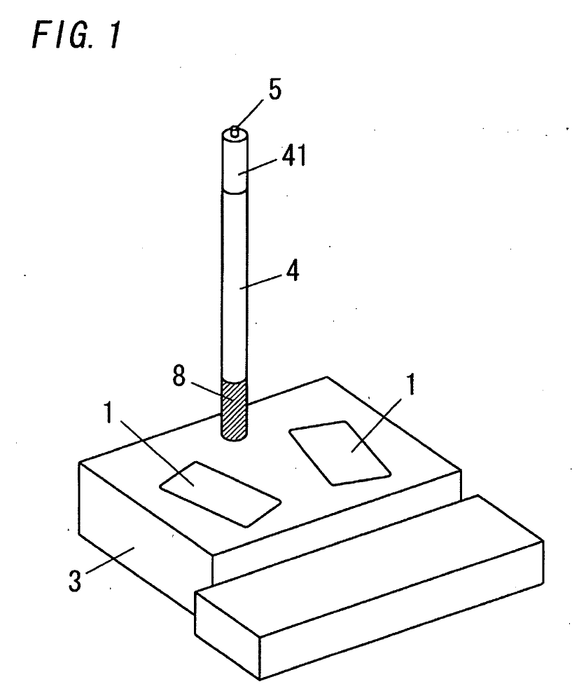

The handle bar 4 prevents the user from having a fall, and is located so as to extend upward from the platform 3 or the step 1. In an example shown in FIG. 1, the handle bar 4 is located so as to extend upward from a central part of a left-and-right direction in a front section of the platform 3, and thereby the user can grip the handle bar 4 with one's left and right hands. A grip 41 for being griped with hand is mounted in an upper end of the handle bar 4.

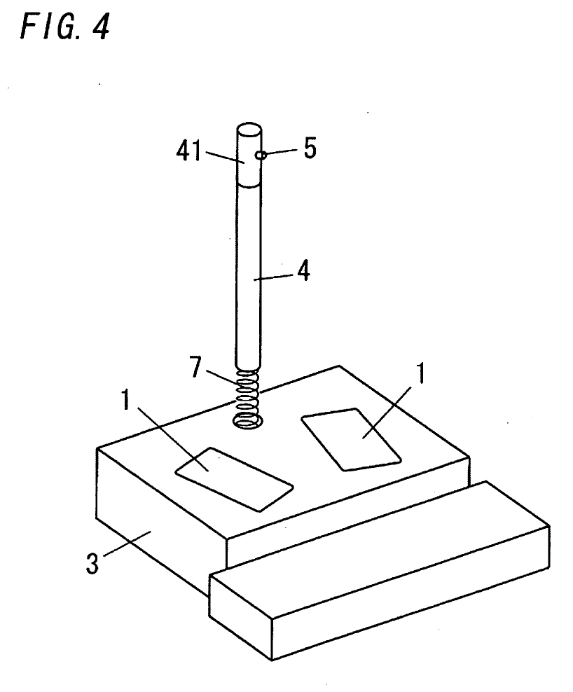

The handle bar 4 is provided with the switch 5 for starting or stopping a passive exercise, or changing types and a dynamic level of the passive exercise. As shown in FIG. 1, the switch 5 may be configured so that a push button extends upward from the upper end of the handle bar 4 and is pushed downward. Or, as shown in FIG. 4, the switch 5 may be configured so that a push button is pushed laterally. In addition, varied operation parts may be used as the switch 5, like a sheet-shaped operation part, or an operation part comprising an electric capacity detection means etc.

The auxiliary exercise equipment comprises the above-mentioned handle bar 4, and can prevent the user from having a fall due to loss of a balance while the user grips the handle bar 4. Then, the user can operate to start and stop a passive exercise and to change types and a dynamic level etc. of the passive exercise via the handle bar 4 easily, immediately and certainly while griping the handle bar 4.

In addition, an elastic member 61 or a viscous member 62 may be located in a connection part connecting the handle bar 4 and the platform 3 or the step 1, or in an intermediate position of the handle bar 4. As shown in FIG. 4, for example, a coil spring is used as the elastic member 61, and as shown in FIG. 1, an oil damper is used as the viscous member 62, although not limited to such the coil spring and the oil damper. For this reason, when the user moves the handle bar 4, a reaction force or a resisting force is generated, and thus a load is generated and the user can train one's muscles.

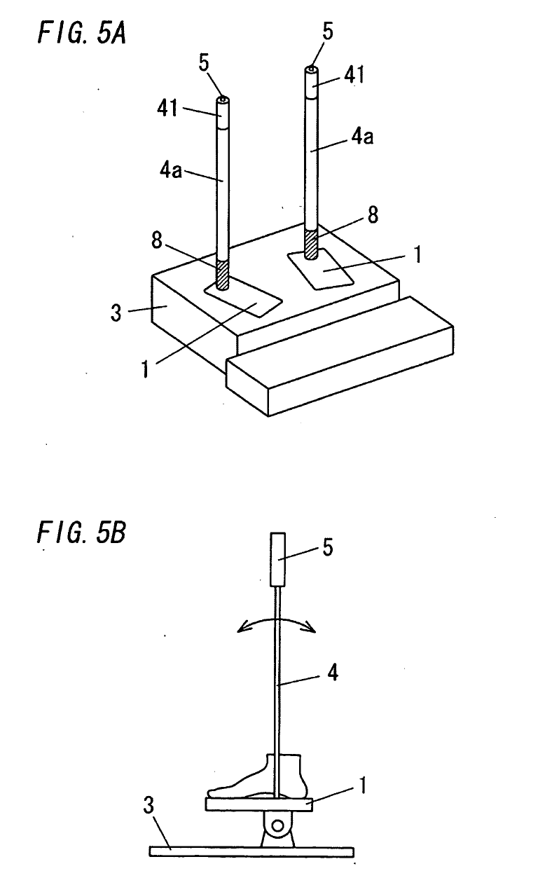

Then, the handle bar 4 may comprise left and right handle bars 4, 4 which are located so as to extend from the left and right steps 1, 1 or left and right sides of a front section of the platform 3, respectively. In an example shown in FIG. 5, the handle bars 4, 4 are located so as to extend from the left and right steps 1, 1, respectively. In this example, the user can grip the left and right handle bars 4, 4 with one's left and right hands, respectively, and thereby the user can get more sense of stability. The left and right handle bar 4, 4 may comprise the switch 5, and thereby a freedom of the switch 5 operation can be increased.

In this case, the user operates the switch 5 mounted in the left and right handle bars 4, 4, and thereby the passive exercise may be started. Thus, the auxiliary exercise equipment can prevent from starting the passive exercise accidentally.

Next, the configuration that the handle bar 4 is located to be movable with respect to the platform 3 is explained.

If the handle bar 4 is located so as to extend from the step 1, as shown in FIG. 10(a), the handle bar 4 and the step 1 are synchronized to move each other in the same phase when the step 1 rotates with respect to the platform 3.

On the other hand, as shown in FIG. 10(b), the handle bar 4 and the step 1 may be moved each other in the opposite phase when the step 1 rotates with respect to the platform 3.

If the handle bar 4 is located in the platform 3, a handle bar driving means 6 drives the handle bar 4. The case rotating the handle bar 4, the case moving the handle bar 4 in a vertical direction, and the case moving the handle bar 4 in a front-back direction or a left-and-right direction are explained.

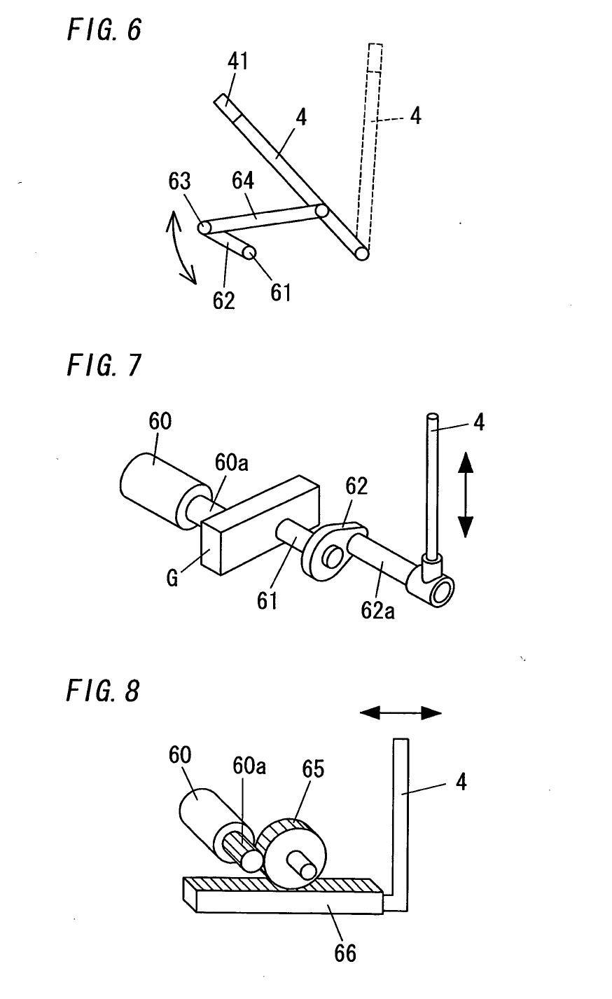

In the case rotating the handle bar 4, as shown in FIG. 6, a motor (not shown) of the handle bar driving means 6 is driven, and a rotative force is transmitted to a crankshaft 61 via a reducer (not shown), and a crankarm 62 is rotated. A crankpin 63 connects an end of the crankarm 62 with one end of a link 64, and the other end of the link 64 is connected to an intermediate position of the handle bar 4. A bottom head of the handle bar 4 is pivotally supported by the platform 3, and the handle bar 4 is rotated by the rotation of the crankarm 62 via the link 64.

In the case moving the handle bar 4 in a vertical direction, as shown in FIG. 7, a motor 60 of the handle bar driving means 6 is driven, and the crankshaft 61 and the crankarm 62 are rotated via a reducer (item G is a gear box). An end of the crankarm 62 is pivotally supported by a bottom head of the handle bar 4, and the handle bar 4 is configured so as to move in a vertical direction by the rotation of the crankarm 62. Item 62a is a connection member connecting the end of the crankarm 62 and the bottom head of the handle bar 4.

In one example of the case moving the handle bar 4 in a front-back direction or a left-and-right direction, as shown in FIG. 8, a gear wheel is mounted in the output shaft 60a of the motor 60, and gears a pinion 65. A rack 66 is moved in a motion direction by the rotation of the pinion 65. A bottom head of the handle bar 4 is fixed into the rack 66, and the handle bar 4 is configured so as to move in a front-back direction or a left-and-right direction by the rotation of the motor 60.

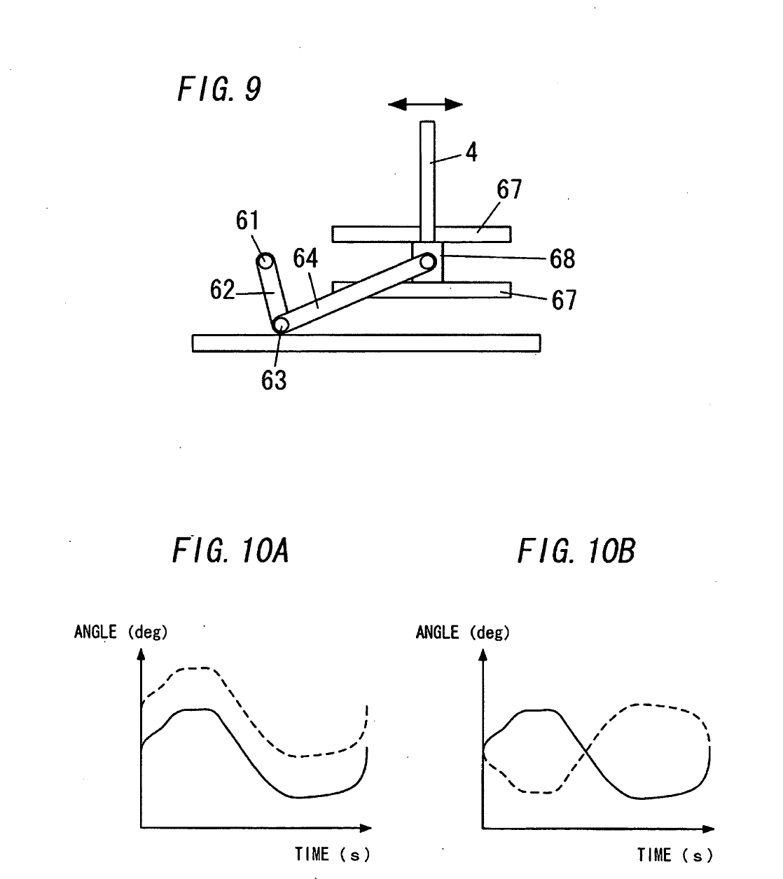

In another example of the case moving the handle bar 4 in a front-back direction or a left-and-right direction, as shown in FIG. 9, the motor 60 of the handle bar driving means 6 is driven, and the crankshaft 61 and the crankarm 62 are rotated via a reducer. An end of the crankarm 62 is pivotally supported by a movement member 68 which can move a guide 67 located along a front-back direction or a left-and-right direction. A bottom head of the handle bar 4 is fixed into the movement member 68, and the handle bar 4 is configured so as to move in a front-back direction or a left-and-right direction by the rotation of the crankarm 62.

According to the above-mentioned configuration, the handle bar 4 is located to be movable with respect to the platform 3, and thus the user can perform not only a passive exercise by the above-mentioned step 1 but a passive exercise by the handle bar 4 or a passive exercise by the combination of the step 1 and the handle bar 4.

The auxiliary exercise equipment may be controlled by changing a stroke of sliding and reciprocating or rotation of the step 1. Or, the auxiliary exercise equipment may be controlled by changing a rotative motion, a motion in a vertical direction, and a motion in a front-back direction or a left-and-right direction of the handle bar 4. For this reason, the user can control a dynamic level of the passive exercise via the switch 5 operation while griping the handle bar 4.

The auxiliary exercise equipment may be configured so that different types of a passive exercise can be changed by the switch 5 operation. Here, the types are a passive exercise performed by step 1, a passive exercise performed by the handle bar 4, and a passive exercise performed by the combination of the step 1 and the handle bar 4. Thus, the user can change the types of the passive exercise while griping the handle bar 4.

1. An auxiliary exercise equipment comprising:
left and right steps on which a user's left and right feet are rested, respectively;
a passive exercise generating means comprising a step rotary driving unit, the step rotary driving unit being configured to change a vertical position relation between front and rear ends of each of the left and right steps while being slid and reciprocated; and
a handle bar for preventing the user from having a fall,
wherein the handle bar is provided with a switch for starting, stopping, or changing a passive exercise.

2. The auxiliary exercise equipment as claimed in claim 1, further comprising a platform, wherein the left and right steps are located on a top surface of the platform,
wherein the handle bar comprises left and right handle bars which are located so as to extend from the left and right steps or left and right sides of the platform, respectively, wherein the user can grip the left and right handle bars with one's left and right hands, respectively, wherein the left and right handle bars comprise the switch.

3. The auxiliary exercise equipment as claimed in claim 1, wherein the handle bar is located to be movable with respect to the platform so that the passive exercise is performed.

4. The auxiliary exercise equipment as claimed in claim 2, wherein the switch is operated by the user and thereby the passive exercise is started.

5. The auxiliary exercise equipment as claimed in claim 1, wherein the switch is operated by the user and thereby a stroke of sliding and reciprocating or rotation of the step is changed in the passive exercise.

6. The auxiliary exercise equipment as claimed in claim 2, wherein the switch is operated by the user and thereby different types of the passive exercise are performed.

7. The auxiliary exercise equipment as claimed in claim 1, wherein an elastic member or a viscous member is located in a connection part connecting the handle bar and the platform or the step, or in an intermediate position of the handle bar.

8. The auxiliary exercise equipment as claimed in claim 2, wherein the handle bar is located to be movable with respect to the platform so that the passive exercise is performed.

9. The auxiliary exercise equipment as claimed in claim 3, wherein the switch is operated by the user and thereby the passive exercise is started.

10. The auxiliary exercise equipment as claimed in claim 8, wherein the switch is operated by the user and thereby the passive exercise is started.

11. The auxiliary exercise equipment as claimed in claim 2, wherein the switch is operated by the user and thereby a stroke of sliding and reciprocating or rotation of the step is changed in the passive exercise.

12. The auxiliary exercise equipment as claimed in claim 3, wherein the switch is operated by the user and thereby a stroke of sliding and reciprocating or rotation of the step is changed in the passive exercise.

13. The auxiliary exercise equipment as claimed in claim 4, wherein the switch is operated by the user and thereby a stroke of sliding and reciprocating or rotation of the step is changed in the passive exercise.

14. The auxiliary exercise equipment as claimed in claim 3, wherein the switch is operated by the user and thereby different types of the passive exercise are performed.

15. The auxiliary exercise equipment as claimed in claim 4, wherein the switch is operated by the user and thereby different types of the passive exercise are performed.

16. The auxiliary exercise equipment as claimed in claim 2, wherein an elastic member or a viscous member is located in a connection part connecting the handle bar and the platform or the step, or in an intermediate position of the handle bar.

17. The auxiliary exercise equipment as claimed in claim 3, wherein an elastic member or a viscous member is located in a connection part connecting the handle bar and the platform or the step, or in an intermediate position of the handle bar.

18. The auxiliary exercise equipment as claimed in claim 4, wherein an elastic member or a viscous member is located in a connection part connecting the handle bar and the platform or the step, or in an intermediate position of the handle bar.

19. The auxiliary exercise equipment as claimed in claim 5, wherein an elastic member or a viscous member is located in a connection part connecting the handle bar and the platform or the step, or in an intermediate position of the handle bar.

20. The auxiliary exercise equipment as claimed in claim 6, wherein an elastic member or a viscous member is located in a connection part connecting the handle bar and the platform or the step, or in an intermediate position of the handle bar.
